(19) United States
(12) Patent Application Publication
(10) Pub. No.: US 2010/0140162 A1
(43) Pub. Date: Jun. 10, 2010

(54) Osmosis membrane with improved flux rate and uses thereof

(76) Inventor: Juzer Jangbarwala, Chino Hills, CA (US)

Correspondence Address: Henry E. Naylor & Associates, LLC, P.O. Box 86060, Baton Rouge, LA, 70879-6060, US

(21) Appl. No.: 12/589,604

(22) Filed: Oct. 26, 2009

Related U.S. Application Data
(60) Provisional application No. 61/197,231, filed on Oct. 24, 2008.
(60) Provisional application No. 61/200,570, filed on Dec. 1, 2008.
(60) Provisional application No. 61/200,588, filed on Dec. 1, 2008.

(51) Int. Cl. B01D 69/10; B01D 61/08

(52) U.S. Cl. 210/490

(57) ABSTRACT

A membrane structure suitable for use in forward osmosis processes, which membrane structure is comprised of a support membrane comprised of ultra high molecular weight polyethylene and having an active surface which active surface contains a cellulosic coating.

### CROSS-REFERENCE TO RELATED APPLICATIONS

This application is based on Provisional Applications U.S. Ser. No. 61/197,231 filed Oct. 24, 2008; U.S. Ser. No. 61/200,570 filed Dec. 1, 2008; and 61/200,588 filed Dec. 1, 2008.

### FIELD OF THE INVENTION

The present invention relates to a membrane structure suitable for use in forward osmosis processes which membrane structure is comprised of a support membrane comprised of ultra high molecular weight polyethylene and having an active surface which active surface contains a cellulosic coating.

### BACKGROUND OF THE INVENTION

Attempts are being made to increase the supply of fresh water around the world. Besides conservation and optimizing the use of water reserves, technology is playing a significant role in providing fresh water to industry and homes.

The most energy intensive step in the treatment of water is typically the removal of dissolved salts. An economically viable method of removing these dissolved salts could lead to producing drinking water from the oceans, or recycling wastewater from industrial processes.

The most dominant technology for the removal of dissolved salts from water today is reverse osmosis. Reverse osmosis is the reverse of the natural process of osmosis utilized by plant roots to absorb water. While reverse osmosis achieves its objective, it does so at very high pressures, and requires an excessive amount of energy, thus making the process uneconomical. It has therefore been an objective of the water treatment community to investigate the natural process of osmosis and to simulate it to reduce energy consumption.

To simulate osmosis (without pressure), a working membrane needs to be of substantially the same thickness as the membrane utilized by roots of natural plants. Unfortunately, such a thin membrane is difficult to handle, much less incorporate into a system. The support layers designed for reverse osmosis membranes impede flux rates when used without pressure. The primary reason for this is because of the thickness and porosity that is required to provide the appropriate amount of support. For example, an osmosis membrane described in U.S. Pat. No. 6,656,361 discloses an asymmetric hydrophilic cellulosic or polyvinyl alcohol (PVA) based membrane comprised of a fabric layer on the back side of the membrane being a polyester net, having about 60% open area and a 0.07 micron thickness. While such a membrane dramatically improves the flux rate over reverse osmosis membranes, it is still impractical for wide spread commercial use.

The flux rate for osmosis membranes is primarily dependent on the osmotic pressure differential existing between the opposite sides of the membrane. The “transition” space defined by the porous fabric support between the back side of the membrane material and the bulk of the liquid with the higher osmotic pressure causes “Internal Concentration Polarization” (ICP). ICP affects the flux because the concentration in the support layer of the membrane drops, reducing the pressure differential. It is therefore desirable to develop a cellulosic, or PVA, membrane having a support layer that is porous, but does not act as an absorbent (such as a plastic), which is extremely thin, yet provides the support needed to form a practical membrane.

Another drawback of using fabric based supports is the “reverse” flow of ions from the draw (higher osmotic pressure) solution into the water to be purified. This becomes very important when the application involves the desalination of seawater to drinking water by the use of solutions made from highly soluble monovalent salts, such as ammonium salts. The use of a support layer that can be functionalized to “repel” ions further improves the desalination that can be achieved.

It is therefore an object of this invention to make an improved composite membrane comprising of an osmosis membrane for use in water purification.

### SUMMARY OF THE INVENTION

In accordance with the present invention there is provided an osmosis membrane structure comprised of a support membrane comprised of ultra high molecular weight polyethylene and having an active surface which active surface contains a cellulosic coating.

In a preferred embodiment the composition of the cellulosic coating is selected from the group consisting of cellulose acetate, cellulose di-acetate, cellulose tri-acetate, cellulose butyrate, cellulose acetate proprionate, and mixtures thereof.

In another preferred embodiment the coating is comprised of a layer from about 10 to about 20 microns thick.

In yet another preferred embodiment of the present invention the ultra high molecular weight polyethylene membrane, without the coating, is about 20 to about 100 microns thick and has a porosity of about 50% to about 95%.

### BRIEF DESCRIPTION OF THE FIGURES

FIG. 1 hereof is a schematic representation of a preferred embodiment for practicing the present invention.

FIG. 2 hereof is a simplified block diagram of one preferred method of practicing the present invention wherein a municipality wastewater stream is passed through an osmosis membrane thereby resulting in a diluted wastewater stream and a concentrated wastewater stream which is passed to an anaerobic digestion plant.

FIG. 3 hereof is a simplified block diagram of another preferred method of practicing the present invention wherein a brine discharge from a desalination plant is used as the draw solution for an osmosis membrane stage, which is used to separate a municipality wastewater stream into a diluted fraction and a concentrated fraction. The concentrated fraction is passed to an anaerobic digestion plant.

FIG. 4 hereof is a simplified block diagram of yet another preferred method for practicing the present invention which is similar to the method shown in FIG. 2 hereof except that a variable volume chamber is used with the osmosis membrane stage which increases the energy of the diluted water stream which is then passed to a generator/turbine to recover part of the energy.

FIG. 5 hereof is a photomicrograph of an UHMWPE membrane without a cellulose coating. The membrane is a commercial UHMWPE marketed under the Tradename Solupore® 3P07A.

FIG. 6 hereof is a photomicrograph of the UHMWPE membrane of FIG. 1, but with a cellulose coating

### DETAILED DESCRIPTION OF THE INVENTION

There are many industrial processes that generate wastewater contaminated with organic constituents. Such contaminants generate very high oxygen demand that is typically expressed as Chemical Oxygen Demand (COD) or Biological Oxygen Demand (BOD). As such, these water streams cannot be discharged to surface bodies of water because they would deplete that body of water of oxygen and adversely affect the habitat of the plants and other life in the body of water. Therefore, treatment of such contaminated water streams is necessary to protect the environment. With the worldwide shortage of water, it is desirable for many industries, from a cost and availability perspective, to recycle such water streams. However, because of the nature of the contaminants, these streams pose much difficulty in applying efficient treatment processes capable of providing water of sufficient quality for recycling. Conventional technologies, such as membrane and ion exchange resin-based processes, are generally not adequate since both require the water, inclusive of the contaminants, to come into contact with the treatment media, which leads to fouling of the media. In the case of membranes, the molecular weight of the organic is too large for use of ultra-filtration, nano-filtration and reverse osmosis membranes which foul very easily due to the pressure applied on the feed stream. Ion exchange resins are >40% water and large molecular weight organics easily foul them.

Currently, as a result of the difficulty in treating these contaminated water streams, they are often treated by such methods as flocculation, dissolved air flotation, as well as other physiochemical means are used to destroy the COD and BOD that is generated by the volatile solids in these streams. These treatments require the addition of relatively high levels of flocculation aids that have a large proportion of dissolved salts associated with them. Additionally, add polymers are often added as coagulation aids. If these water streams are to be recycled, the polymers must be removed before the salt removal system can be applied. The many steps required to recycle the water hence make the economics unattractive. Consequently, there remains a need in the art to provide a low cost method for treating such contaminated water streams as well as recycling substantially uncontaminated water.

The present invention relates to an osmosis process, which is a natural process of water absorption used by plant roots. For purposes of clarity, this is the opposite of reverse osmosis, which is presently popular in water treatment. Osmosis is also sometimes referred to as “forward Osmosis” or “Direct Osmosis” in the water treatment business. In osmosis, a semi-permeable membrane is used to attract substantially pure water into a solution with high osmotic pressure from a solution at low osmotic pressure. In one embodiment of the present invention, the high osmotic pressure solution is seawater and the low osmotic pressure solution is fresh water contaminated with municipality sewage, or other low osmotic pressure fluid, that is predominantly organic in nature.

Osmotic pressure exerted by a fluid is a function of the amount of dissolved salts in the fluid, their molecular weight, (hence molar concentration) and temperature. It is defined by the following equation:

π=φηMRT

### Wherein:

π=Osmotic Pressure in atmospheres
φ=Degree of dissociation of a salt/molecule in solution (unitless, expressed in fraction)
η=Number of ions the salt in question dissociates into in an aqueous solution. Unitless
M=Molarity of salt. (Moles/Liter)
R=Gas Constant=0.0821 atm-liters/mole-° K.

### T=Temperature in ° K. (° C.+273)

In one embodiment of the present invention, difficult to treat industrial wastewater streams are exposed to a semi permeable membrane without pressure. The membrane separates the waste stream from a saline solution having a high osmotic pressure. The membrane allows only water to travel through the membrane from the contaminated water side to the saline water side due to the differential osmotic pressure. The industrial wastewater can be from any source. Non-limiting examples of sources of contaminated water include: food manufacturing, bakeries, potato chips, etc; textile and carpet dyeing; slaughter houses; dairy, sheep and pig farms; oil and gas industry produced water and refinery wastewater; landfill leachate water; regeneration waste discharge from ion exchange systems; mining operations wastewater; agricultural runoff or vegetable/fruit washing operation wastewater; black liquor and other wastewater from the paper & pulp manufacturing industry, and aluminum anodizing industry wastewater.

The present invention also relates to a process which uses, as a draw solution, available brackish water, seawater or a substantially sterile salt solution having high osmotic pressure such as NaCl or other monovalent ionic salt in water, with a concentration from about 5 g/L to 250 g/L; preferably from about 20 g/L to 200 g/L; and more preferably from about 35 g/L to 50 g/L. Any suitable solution that exerts osmotic pressure can be used in the practice of the present invention.

The draw solution in one embodiment of the present invention is used to remove water from the wastewater through a semi-permeable membrane. Preferably, the osmosis membrane is in a plate and frame configuration or a spiral wound configuration. More preferably, the osmosis membrane is in a plate and frame configuration. It is also preferred that the osmosis membrane is constructed of materials selected from the group consisting of composite thin film membranes such as polyamides with polysulfone substrate, more preferably cellulose acetate, as well as other cellulose compound layers embedded in an asymmetric woven support as described by the commercial product marketed by Hydration Technologies, Inc., (HTI) of Albany Oreg. Most preferred is a composite asymmetric membrane comprised of cellulosic, polyamide or other semi permeable hydrophilic materials embedded in a high porosity, hydrophobic ultra high molecular weight polyethylene (UHMWPE) membrane. It is preferred that a cellulosic material be used. In other words, in a preferred embodiment, the osmosis membranes of the present invention are formed by depositing a cellulosic material onto a thin UHMWPE membrane. UHMWPE materials are well known in the art and are typically synthesized from monomers of ethylene, which are bonded together to form the ultra-high-molecular-weight polyethylene material. These are molecules of polyethylene that are several orders of magnitude longer than familiar high-density polyethylene (HDPE) due to a synthesis process based on metallocene catalysts. In general, HDPE molecules have between 700 and 1,800 monomer units per molecule, whereas UHMWPE molecules tend to have 100,000 to 250,000 monomers each. Further, UHMWPE is a type of polyolefin, and, despite relatively weak Van der Waals bonds between its molecules, derives ample strength from the length of each individual molecule. It is made up of extremely long chains of polyethylene, which all align in the same direction. Each chain is bonded to the others with so many Van der Waals bonds that the whole can support great tensile loads.

Non-limiting examples of cellulosic materials that can be used in the practice of the present invention include cellulose acetate, cellulose di-acetate, cellulose tri-acetate, cellulose acetate butyrate, cellulose acetate proprionate as well as other combinations of cellulosic materials thereof. Preferably, cellulose layer will be about 5 to about 150 microns, preferably from about 5 to 100 microns, more preferably from about 5 to about 50 microns, and most preferably from about 10 to about 20 microns thick. The cellulosic coating will be integrally deposited onto the UHMWPE membrane which will typically have a thickness from about 20 to about 200 microns, preferably from about 20 to about 150 microns, more preferably from about 20 to about 100 microns thick and will have a porosity of about 50% to about 95% porosity, with substantially no absorbent qualities. Further, the UHMWPE membrane layer will preferably be prepared from a mixture of the UHMWPE polymer and the cellulose compound, in a fashion where the amount of the cellulose compound in the UHMWPE layer decreases from the deposited cellulose compound layer to the opposite side of the membrane. Such a membrane is commercially available from Lydall Corporation under the brand name Solupore®.

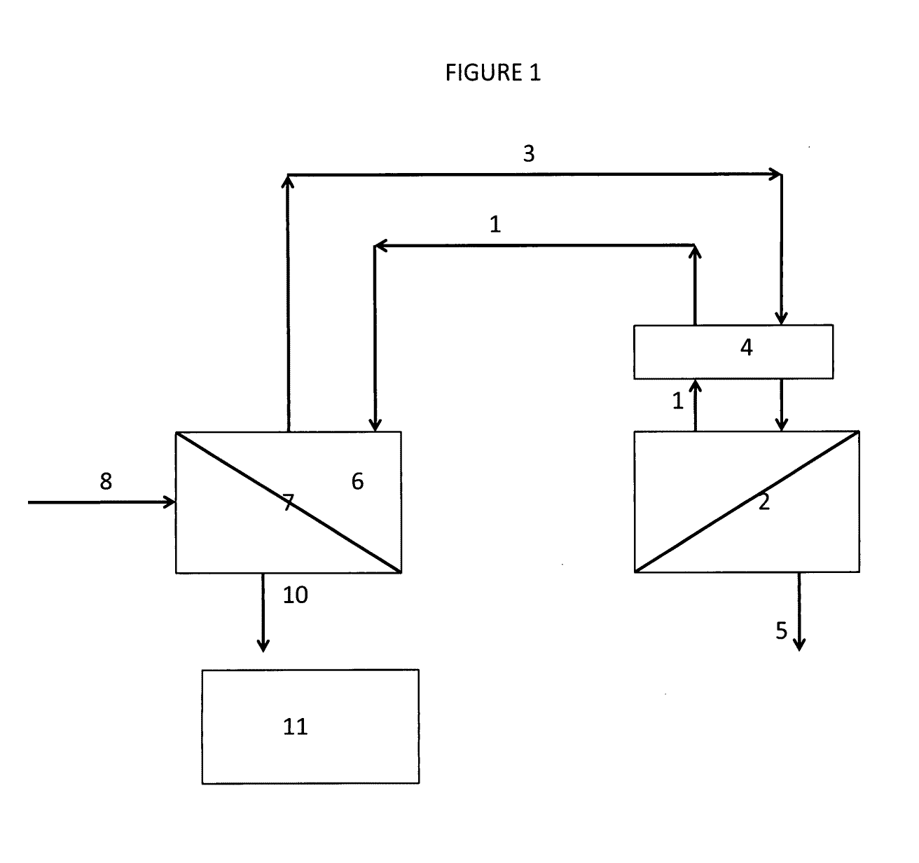

The use of the present invention to treat organic wastewater streams can be illustrated in FIG. 1 hereof wherein the draw solution 1 (9-10% NaCl brine) will be generated by a high pressure reverse osmosis system 2 as a concentrate from processing salt solution at seawater level salinity (3.5%-5.0% salt) 1 is sent through a pressure based energy recovery device 4 which reduces the pressure to 200 psig, and passed at low pressure, in the osmosis system 6, counter current to the wastewater 8 separated by the osmosis membrane 7. The wastewater will be concentrated by a factor inversely proportional to the salt content in it and directed to further treatment. The concentrated waste solution 10 can be directed to various treatment methodologies (11), such as anaerobic digestion to generate methane, burn as fuel in boilers, etc. The brine (draw) solution 1 will pull pure water from the wastewater, and get diluted to approximately the salinity of seawater 3 and sent back to the reverse osmosis system 2. The diluted solution 3 will first be sent through the energy recovery system 4 and subsequently pressurized to 800-1000 psig and treated with a standard reverse osmosis seawater desalination system 2. The permeate 5 (purified water) from the seawater desalination system is sent back to be recycled. Water and salt solution can be added to the closed loop as needed to maintain energy and mass balance.

Another embodiment of the present invention relates to a way to reduce the volumes of smaller municipality waste-water streams in communities along the seawater coast, offshore platforms, or on board ships. A preferred embodiment of the present invention involves the use of an environmentally viable and relatively inexpensive anaerobic digestion process that results in renewable energy.

Efforts have been made to make anaerobic digestion of human and animal wastes more economically viable, but most have involved the introduction of energy such as heat or the use of membrane filtration with pressure, such as with Ultrafiltration or Microfiltration. The use of energy defeats the purpose of energy recovery from such wastes for two reasons. First, the use of electricity consuming processes, such as pressure based membrane filtration to concentrate the waste volume to be treated, or the use of thermal energy for evaporation/reduction of volume. Both processes consume most of the energy recovered by the digestion method. Thermal evaporation techniques also decompose the waste, further destroying the components which produce methane for further energy recovery. Second, membrane filtration of such wastes has not been very successful because of intimate contact required with the membrane surface under pressure. Also, such wastes typically contain high levels of suspended solids, which must be removed by extensive pre-treatment systems.

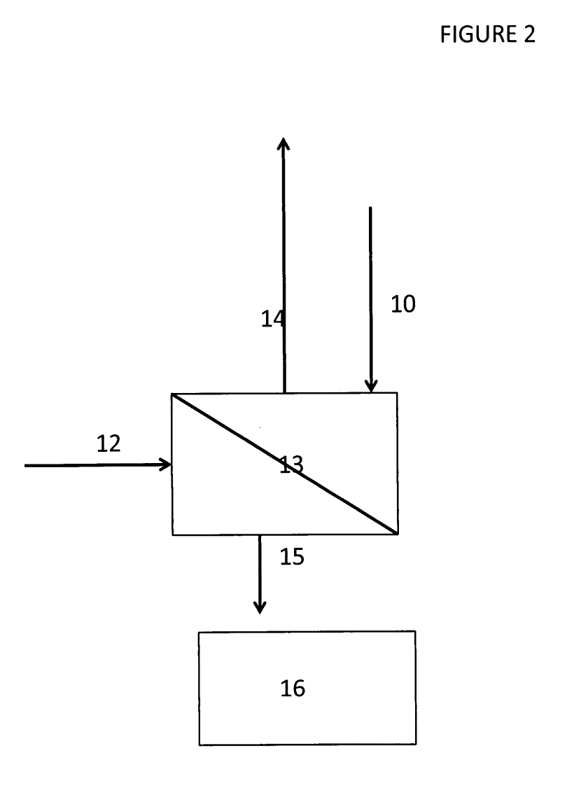

FIGS. 2, 3 and 4 hereof relate to the treatment of municipal waste by the practice of the present invention. FIG. 2 hereof wherein the draw solution 12 is passed counter current to the municipality wastewater 13 separated by the osmosis membrane 14. The resulting diluted wastewater 15 will be discharged. The concentrated municipality wastewater 15 can optionally be sent to an anaerobic digestion plant 16 or discharged to the sewer.

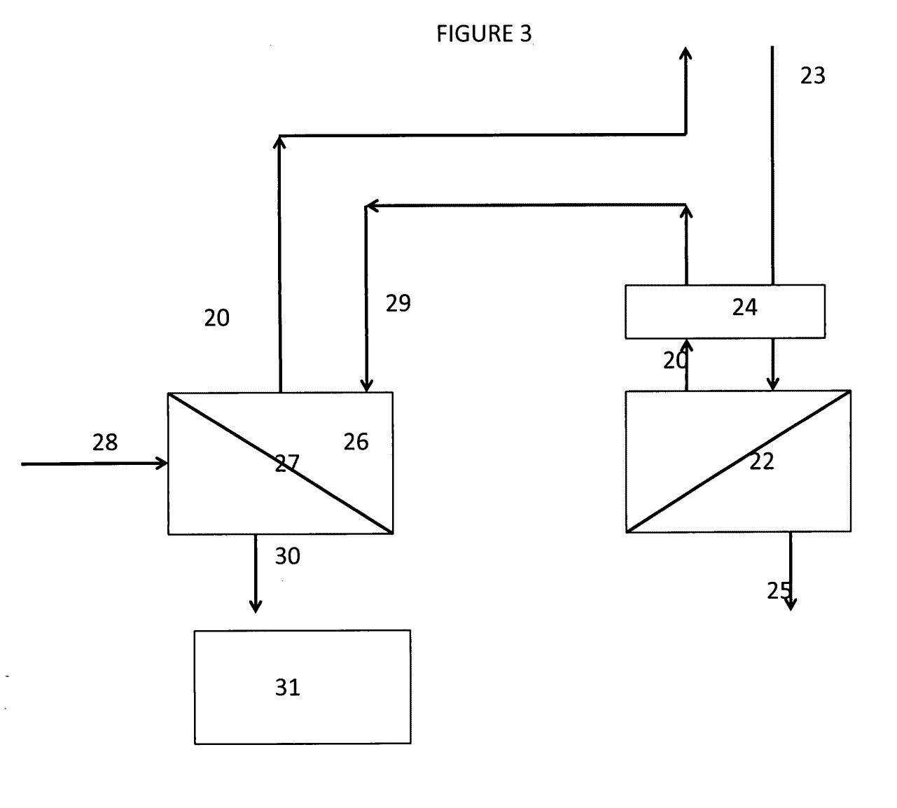

Another preferred embodiment of the present invention is shown in FIG. 3 hereof wherein the draw solution is a brine discharge 20 from a seawater desalination system 22. Seawater 23 is passed through an energy recovery device 24 such as that manufactured by Energy Recovery Systems, CA, USA and pressurized from the pressure of the outgoing concentrated brine discharge 20. The pre-pressurized seawater is then further pressurized to typical operating pressures of about 800-1000 psig for desalination in the desalination system 22. The resulting purified drinking water 25 can then supplied to residences. The brine discharge 20, now depressurized to about 200 psig, and having a higher concentration of salt, is then sent to an osmosis system 26. The osmosis system 26 has the osmosis membrane 27, as described by this invention, which allows pure water from the municipality waste stream 28 to transfer to the high salt concentration brine, thus diluting it back to seawater levels, creating a dischargeable stream 29. The concentrated municipality water 30 can now be sent to a much smaller (typically 50%) optional anaerobic digestion system, 31, where conventional means can be used to derive methane for energy, but with an unexpected 200% efficiency. This embodiment provides a very ecological method of desalinating seawater without the detrimental effects of high salt brine being discharged back to the sea. This is particularly useful in areas that have very sensitive habitats, such as coral reefs and associated life in the Great Barrier Reef off of the Australian coast. In this embodiment, fresh water can be provided to coastal communities via a reverse osmosis desalination system. Simultaneously, the wastewater from a municipality wastewater plant can be concentrated by the brine discharge of the desalinator before it is finally discharged to the sea. The diluted brine, after the osmosis process, will be about equivalent to the salt content of the original seawater. It should be noted that this technique can be applied to very small, individual residences also. The coastal homeowner, who lives in a water storage area, and have access to either shallow wells or surface seawater, can take the grey water and sewage water generated at their home, and concentrate it using the brine discharge from a desalter unit and discharge the resulting concentrated sewage water to the municipality drain, while at the same time generating fresh water from the sea and discharging back to the sea, water quality roughly equal to the original seawater.

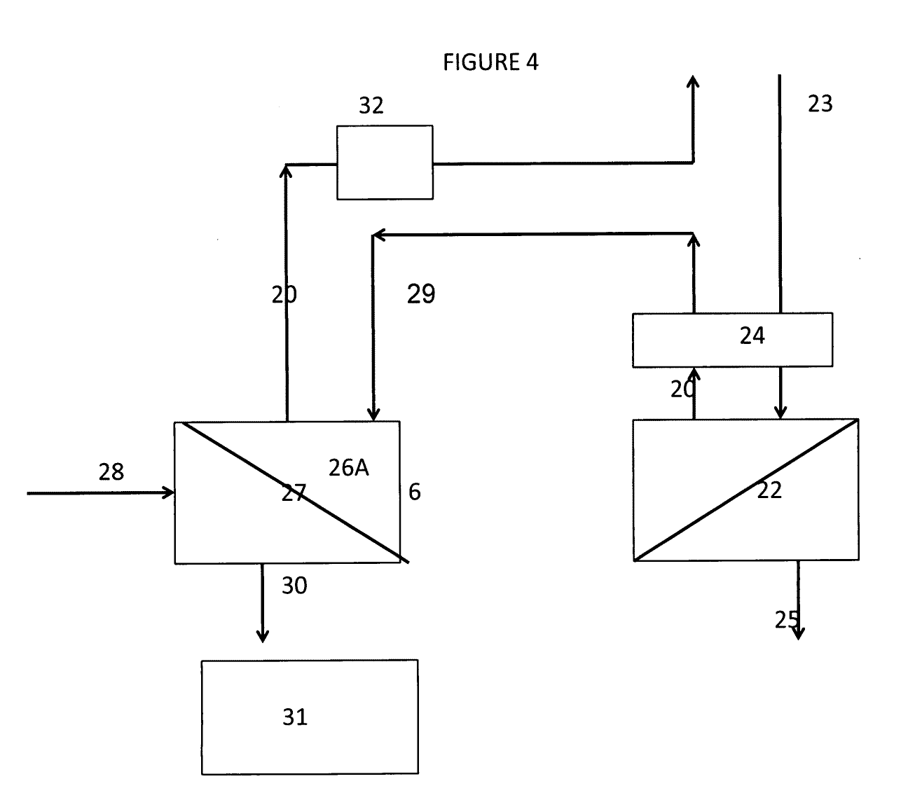

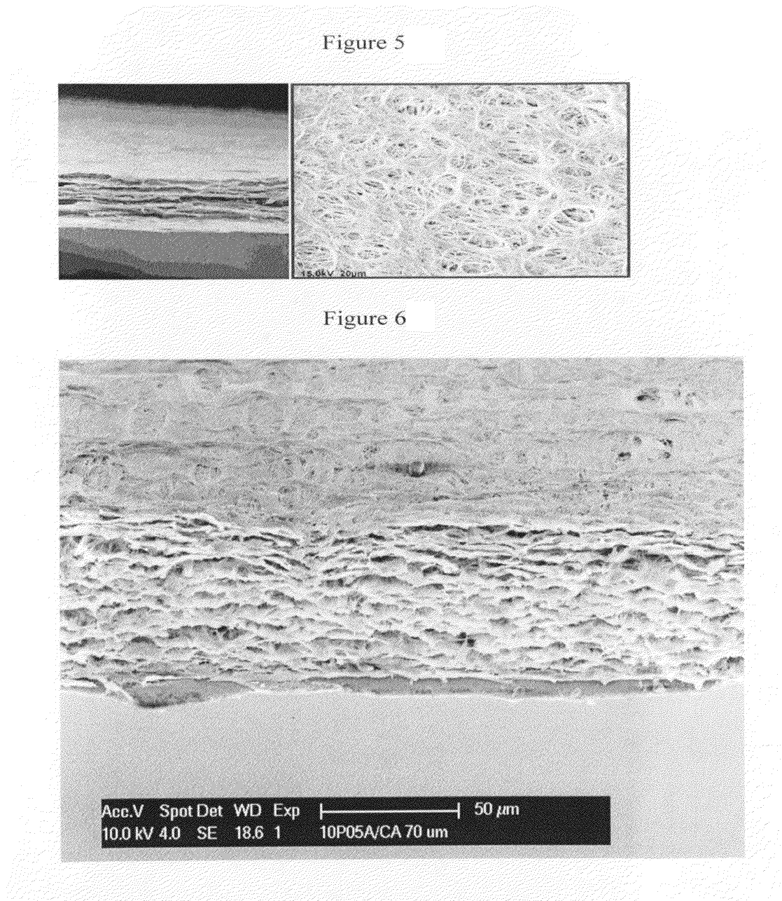

In yet another embodiment, adding to FIG. 3 hereof, and referring to the new figure as FIG. 4 hereof, the brine discharge 20 from the seawater desalination unit is contained in a constant pressure, variable volume chamber 26A. The increase in water volume at the 200 psig pressure hence increases the energy content of the water, such that the kinetic energy upon release of the diluted stream 29 through a generator/turbine 32 can recover part of the energy as electrical energy, thus helping subsidize the power consumption of the desalination system.

In all of the above embodiments, it should be noted that the concentration of the municipality wastewater by an order of magnitude now increases the concentration of the volatile solids in the waste, and hence very small footprint bio-gas generation plant can be employed. This concept of concurrent bio gas generation is an important aspect of this invention and is incorporated herewith.

The following examples are presented for illustrative purposes only and are not to be taken as being limiting in anyway.

### EXAMPLES

A UHMWPE (hydrophillic form of Solupore 3P07A) was used to fabricate a membrane having the dimensions 7 cm×13 cm. Membrane under the tradename “Solupore” are available from the Lydall Corporation. A 60 micron thick membrane having a porosity of 85% was prepared using cellulose tri-acetate (CTA) salts coated onto the UHMWPE membrane. The CTA salts were coated such that the density of CTA gradually decreased from the front of the membrane to the back. A dense layer (10 microns thick) of CTA was deposited on the UHMWPE membrane.

An experiment was performed to compare the flux rate of the cellulosic coated membrane of the present invention compared to a commercially available osmosis membrane. The commercially available membrane was a forward osmosis polyamide/sulfone membrane available from Hydration Technologies, Inc. (HTI) of Albany, Oreg. Two devices (each with two chambers 4″×1″×1″) were built with acrylic. A 1 square cm hole connected the chambers. A 1 square cm piece of the cellulosic coated membrane of the present invention was mounted in one and a 1 square cm piece of the commercial membrane was mounted in a similar manner. Each device consisted of two chambers, fused together, with a hole of 1 cm² surface area between them. A membrane sample was sandwiched between the chambers, such that the only fluid connection between the chambers was through the membranes

A commercially utilized monosaccharide based sugar solution having a high osmotic pressure commonly used to operate osmosis units called “forward osmosis” devices was used as a draw solution. The water to be concentrated was prepared as a 4100-4200 ppm NaCl solution in deionized water. A 24 hour test was performed with the following results:

| | Coated Membrane of | Commercial |
|---|---|---|
| | This Invention | HTI Membrane |
| Start Volume | 40 ml | 40 ml |
| End Volume | 37 ml | 39.5 ml |
| Start TDS (9 to 1 Dilution) | 410-420 | 410-420 |
| End TDS (9 to 1 Dilution) | 440 | 420 |
| Surface Area | 1 cm² | 1 cm² |
| Hours | 24 | 24 |
| Flux | 3 ml/cm²-24 hrs | 0.5 ml/cm²-24 hrs |
| Flux | 1350 ml/M²-hr | 208 ml/M²-hr |

An unexpected 600%+ improvement in flux rate was observed for the coated membrane of this invention. Since the membrane and CTA thicknesses were similar to the commercially available membrane, the expected performance would have been only a marginal improvement. However, the increase in flux was significantly and unexpectedly higher. We believe that given this data of unexpected increase in performance, the flux rate will be at least an order of magnitude higher than currently available membranes when a cellulosic coated layer is used and when thinner layers of UHMWPE are used.

It is believed that the lack of an absorbent layer as support makes a substantial difference in reducing, if not eliminating, the internal concentration polarization (ICP) effect. Further improvements in flux will result from shorter paths through thinner membrane, and higher pull effect from the draw solution on the feed solution due to thinner membrane layers.

What I claim:

1. An osmosis membrane structure comprised of a support membrane comprised of ultra high molecular weight polyethylene and having an active surface which active surface contains a cellulosic coating.

2. The osmosis membrane of claim 1 wherein the composition of the cellulosic coating is selected from the group consisting of cellulose acetate, cellulose di-acetate, cellulose tri-acetate, cellulose butyrate, cellulose acetate proprionate, and mixtures thereof.

3. The osmosis membrane of claim 1 wherein the coating is comprised of a layer from about 5 to about 150 microns thick.

4. The osmosis membrane of claim 1 wherein the ultra high molecular weight polyethylene membrane, without the coating, is about 20 to about 200 microns thick and has a porosity of about 50% to about 95%.

5. The osmosis membrane of claim 1 wherein the cellulosic coating decreases in density from the active surface on which it is deposited to the opposite side of the membrane.
